(19) United States
(12) Patent Application Publication
(10) Pub. No.: US 2010/0201672 A1
(43) Pub. Date: Aug. 12, 2010

(54) PLASMA DISPLAY APPARATUS

(76) Inventors: Jongsik Lim, Gyoungsangbuk-do (KR); Yangki An, Gyoungsangbuk-do (KR)

Correspondence Address: KED & ASSOCIATES, LLP, P.O. Box 221200, Chantilly, VA, 20153-1200, US

(21) Appl. No.: 12/679,551

(22) PCT Filed: May 18, 2009
(86) PCT No.: PCT/KR09/02614

§ 371 Date: Mar. 23, 2010

(30) Foreign Application Priority Data
Jun. 5, 2008 (KR) 10-2008-0053308

(51) Int. Cl. G09G 3/28; G06F 3/038

(52) U.S. Cl. 345/211; 345/60

(57) ABSTRACT

A plasma display apparatus is disclosed. The plasma display apparatus includes a plasma display panel having an electrode, a driver, and a first circuit protection unit. The driver supplies the electrode with at least one of a bias voltage, a reference voltage of the bias voltage, a sustain voltage, and a reference voltage of the sustain voltage. The first circuit protection unit allows the bias voltage to be supplied and allows the supply of the reference voltage of the bias voltage to be terminated in a first malfunction mode where the bias voltage and the reference voltage of the bias voltage are simultaneously supplied.

### TECHNICAL FIELD

This document relates to a plasma display apparatus.

### BACKGROUND ART

A plasma display apparatus includes a plasma display panel and a driver. The plasma display panel includes discharge cells that are partitioned by barrier ribs. As the driver supplies a driving signal to electrodes of the plasma display panel, a discharge occurs at a discharge cell correspondingly, and this excites phosphor contained in the discharge cell to emit light.

A plasma display apparatus expresses gray levels according to a combination of subfields. That is, a plasma display apparatus emits light during each subfield and a gray level is represented by sum of amounts of light emitted outwardly during each subfield.

Each subfield includes a reset period, an address period, and a sustain period. Wall charges are uniformly created at the overall discharge cells of the plasma display panel during a reset period. Discharge cells to emit light are selected during an address period. Light is emitted from the selected discharge cells during a sustain period.

### DISCLOSURE OF INVENTION

### Technical Problem

The driver of the plasma display apparatus needs to supply a driving signal to electrodes of a plasma display apparatus through the stable operation.

### Technical Solution

In an aspect, a plasma display apparatus comprises a plasma display panel having an electrode, a driver adapted to supply the electrode with at least one of a bias voltage, a reference voltage of the bias voltage, a sustain voltage, and a reference voltage of the sustain voltage, and a first circuit protection unit adapted to allow the bias voltage to be supplied and allow the supply of the reference voltage of the bias voltage to be terminated in a first malfunction mode where the bias voltage and the reference voltage of the bias voltage are simultaneously supplied.

The first circuit protection unit may include a first control unit adapted to output a first control signal for terminating the supply of the reference voltage of the bias voltage in the first malfunction mode where the bias voltage and the reference voltage of the bias voltage are simultaneously supplied, and a first logic circuit adapted to receive the first control signal to terminate the supply of the reference voltage of the bias voltage.

The plasma display apparatus may further comprise a second circuit protection unit adapted to allow the supply of the sustain voltage and the reference voltage of the sustain voltage to be terminated in a second malfunction mode where the sustain voltage and the reference voltage of the sustain voltage are simultaneously supplied.

The second circuit protection unit may include a second control unit adapted to output a second control signal for terminating the supply of the sustain voltage and the reference voltage of the sustain voltage in the second malfunction mode where the sustain voltage and the reference voltage of the sustain voltage are simultaneously supplied, and a second logic circuit unit adapted to receive the second control signal to terminate the supply of the reference voltage of the sustain voltage.

The first control unit may include a first AND gate and a first control switch, and the first logic circuit unit may include a second AND gate, in the first malfunction mode, the first AND gate may output a high signal to a bias voltage control terminal of the driver and a control terminal of the first control switch, the first control switch may supply a low signal to an input terminal of the second AND gate, the second AND gate may supply a low signal to a reference voltage control terminal of the driver to terminate the supply of the reference voltage.

Input terminals of the first AND gate may be connected to each other, an output terminal of the first AND gate may be connected to a control terminal of a switch controlling a bias voltage, the output terminal of the first AND gate may be connected to the control terminal of the first control switch, and one of input terminals of the second AND gate may be connected to the first control switch, the other of input terminals of the second AND gate may be connected to an input terminal supplying a control signal to a control terminal of the reference voltage control switch of the bias voltage.

The second control unit may include a third AND gate and a second control switch, and the second logic circuit unit may include a second AND gate and a fourth AND gate, in the second malfunction mode, the third AND gate may output a high signal to a control terminal of the second control switch, an input terminal of the second AND gate may receive a low signal when the second control switch turns on to terminate the supply of the reference voltage of the sustain voltage, an input terminal of the fourth AND gate may receive a low signal when the second control switch turns on to terminate the supply of the sustain voltage.

Input terminals of the third AND gate may be connected to an input terminal of the second AND gate and an input terminal of the fourth AND gate, respectively, an output terminal of the fourth AND gate may be connected to a sustain voltage control terminal, an output terminal of the second AND gate may be connected to a reference voltage control terminal of the sustain voltage, an output terminal of the third AND gate may be connected to a control terminal of the second control switch, the other of the input terminals of the fourth AND gate may be connected to the second control switch, the other of the input terminals of the second AND gate may be connected to the second control switch.

The reference voltage of the sustain voltage may be equal to the reference voltage of the bias voltage.

In an aspect, A plasma display apparatus comprises a plasma display panel having an electrode, a driver adapted to supply the electrode with at least one of a bias voltage, a reference voltage of the bias voltage, a sustain voltage, and a reference voltage of the sustain voltage, and a second circuit protection unit adapted to allow the supply of the sustain voltage and the reference of the sustain voltage to be terminated in a second malfunction mode where the sustain voltage and the reference voltage of the sustain voltage are simultaneously supplied.

The second circuit protection unit may include a second control unit adapted to output a second control signal for terminating the supply of the sustain voltage and the reference voltage of the sustain voltage in the second malfunction mode where the sustain voltage and the reference voltage of the sustain voltage are simultaneously supplied, and a second logic circuit unit adapted to receive the second control signal to terminate the supply of the reference voltage of the sustain voltage.

The second control unit may include a third AND gate and a second control switch, and the second logic circuit unit may include a second AND gate and a fourth AND gate, in the second malfunction mode, the third AND gate may output a high signal to a control terminal of the second control switch, an input terminal of the second AND gate may receive a low signal when the second control switch turns on to terminate the supply of the reference voltage of the sustain voltage, an input terminal of the fourth AND gate may receive a low signal when the second control switch turns on to terminate the supply of the sustain voltage.

Input terminals of the third AND gate may be connected to an input terminal of the second AND gate and an input terminal of the fourth AND gate, respectively, an output terminal of the fourth AND gate may be connected to a sustain voltage control terminal, an output terminal of the second AND gate may be connected to a reference voltage control terminal of the sustain voltage, an output terminal of the third AND gate may be connected to a control terminal of the second control switch, the other of the input terminals of the fourth AND gate may be connected to the second control switch, the other of the input terminals of the second AND gate may be connected to the second control switch.

### Advantageous Effects

The plasma display apparatus according to the exemplary embodiment may stably supply a driving signal so that the reliability in operation may be accomplished.

The circuit protection unit of the plasma display apparatus prevents malfunction of the sustain driver to protect the sustain driver.

When the first malfunction mode occurs, the first circuit protection unit prevents a short circuit from being made within the sustain driver, thus making it possible to prohibit malfunction of the sustain driver.

When the second malfunction mode occurs, the second circuit protection unit prevents a short circuit from being made within the sustain driver, thus making it possible to prohibit malfunction of the sustain driver.

When the first malfunction mode and the second malfunction mode occur at the same time or separately from each other, the third circuit protection unit prevents a short circuit from being made within the sustain driver, thus making it possible to prohibit malfunction of the sustain driver.

### BRIEF DESCRIPTION OF DRAWINGS

FIG. 1 is a view illustrating a plasma display apparatus according to an exemplary embodiment.

FIG. 2 is a view illustrating driving signals of a plasma display apparatus according to an exemplary embodiment.

FIG. 3 is a view illustrating an example of the circuit protection unit shown in FIG. 1.

FIG. 4 is a view illustrating another example of the circuit protection unit shown in FIG. 1.

FIG. 5 is a view illustrating still another example of the circuit protection unit shown in FIG. 1.

### BEST MODE FOR CARRYING OUT THE INVENTION

Hereinafter, detailed descriptions of exemplary embodiments will be given with reference to accompanying drawings. The above and other objects, features, and advantages of this document will become more apparent from the following detailed description of exemplary embodiments with reference to the accompanying drawings.

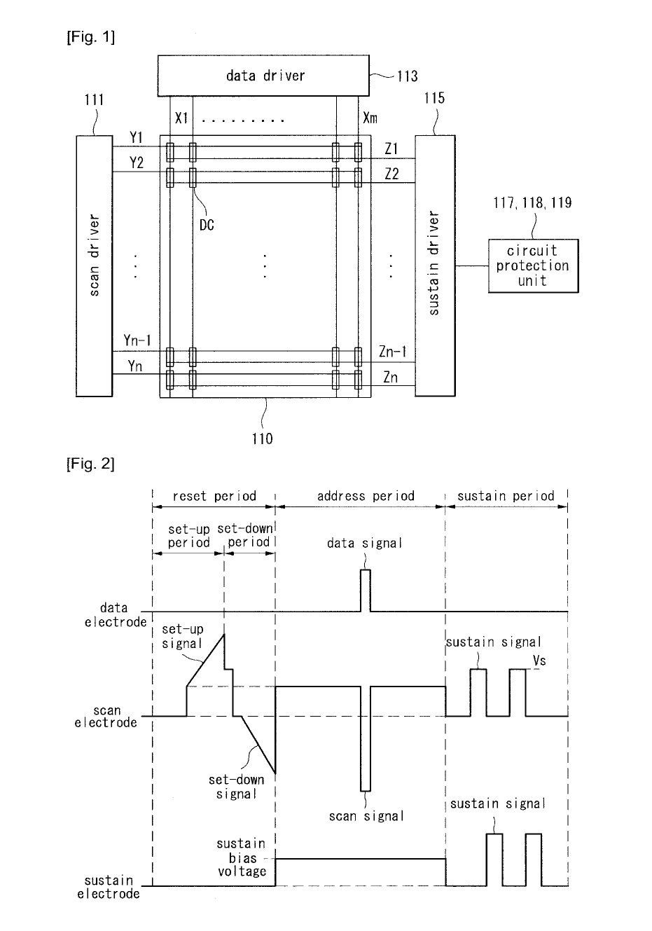

FIG. 1 is a view illustrating a plasma display apparatus according to an exemplary embodiment. FIG. 2 is a view illustrating driving signals of a plasma display apparatus according to an exemplary embodiment. Referring to FIG. 1, a plasma display apparatus according to an exemplary embodiment includes a plasma display panel 110, a scan driver 111, a data driver 113, a sustain driver 115, and a circuit protection unit 117, 118, and 119.

The plasma display panel 110 includes scan electrodes Y1 to Yn, sustain electrodes Z1 to Zn, and data electrodes X1 to Xm. The scan electrodes Y1 to Yn and the sustain electrodes Z1 to Zn are arranged to be parallel with each other, and the data electrodes X1 to Xm are arranged to intersect the scan electrodes Y1 to Yn and the sustain electrodes Z1 to Zn. Discharge cells DC are located around the intersections of the data electrodes X1 to Xm, and the scan electrodes Y1 to Yn and the sustain electrodes Z1 to Zn.

The scan driver 111 supplies a set-up signal to the scan electrodes Y1 to Yn during the reset period of a subfield. As the set-up signal is supplied, a sufficient amount of wall charges are created at discharge cells of the plasma display panel 110.

The scan driver 111 supplies a set-down signal to the scan electrodes Y1 to Yn during a reset period. When the set-down signal is supplied, the wall charges created at the discharge cells DC are partially erased so that the wall charges are uniformly distributed within the entire discharge cells DC of the plasma display panel 110.

The scan driver 111 supplies a scan signal during an address period. The data driver 113 supplies the data electrodes X1 to Xm with a data signal that is synchronous with the scan signal. As the scan signal and the data signal are supplied, there are selected discharge cells DC where sustain discharges will occur.

The sustain driver 115 supplies a bias voltage to the sustain electrodes Z1 to Zn during an address period. As the bias voltage is supplied, address discharges smoothly occur between the scan electrodes Y1 to Yn and the address electrodes X1 to Xm.

The scan driver 111 and the sustain driver 115 alternately supplies the scan electrodes Y1 to Yn and the sustain electrodes Z1 to Zn with a sustain signal that rises up to the sustain voltage Vs during a sustain period. As the sustain signal is supplied, sustain discharges are created at the discharge cells where an address discharge occurred, so that light is emitted.

The circuit protection unit 117, 118, and 119 prevents malfunction of the sustain driver 115 to protect the sustain driver 115.

### Mode for the Invention

FIG. 3 is a view illustrating an example of the circuit protection unit shown in FIG. 1.

A sustain driver 115 is shown at the right part of FIG. 3. The sustain driver 115 supplies a bias voltage Vbias and a sustain signal. The process of supplying the sustain signal is as follows.

A first switch S1 maintains a turn-on state and a second switch S2 is turned on, while a third switch and a fourth switch S3 and S4 maintain a turn-off state. Accordingly, a sustain voltage Vs is supplied to a sustain electrode Z.

Whereas the third switch S3 turns on, the first switch S1, the second switch S2, and the fourth switch S4 turn off. Accordingly, electric charges are recovered from the sustain electrode Z to a capacitor C through an inductor L. Since resonance is made between the inductor L and the capacitance component of the plasma display panel, the voltage at the sustain electrode Z gradually drops from the sustain voltage Vs to the reference voltage of the sustain voltage Vs. At this time, the reference voltage of the sustain voltage Vs may be a ground voltage (GND).

The third switch S3 maintains a turn-on state, the fourth switch S4 turns on, and the first switch S1 and the second switch S2 maintain a turn-off state. Accordingly, a reference voltage is supplied to the sustain electrode Z.

Further, a fifth switch 55 and a sixth switch S6 turn on during an address period, and thus, the sustain driver 115 supplies the bias voltage Vbias to the sustain electrode Z.

When the fourth switch S4, the fifth switch S5, and the sixth switch S6 are turned on in the middle of supplying the bias voltage Vbias, the bias voltage Vbias and the reference voltage of the bias voltage Vbias are simultaneously supplied, and this causes a short circuit to be made within the sustain driver 115. Thus, the sustain driver 115 may cause malfunction, and at its worst, the sustain driver 115 may break down.

A first circuit protection unit 117 includes a first control unit 310 and a first logic circuit unit 320 to prevent the malfunction of the sustain driver 115.

The first control unit 310 outputs a first control signal for terminating the supply of the reference voltage of the bias voltage in a first malfunction mode where the bias voltage Vbias and the reference voltage of the bias voltage are supplied simultaneously. In the exemplary embodiment, the first malfunction mode refers to a situation where a high signal is supplied to the control terminal T of the fifth switch S5 and the sixth switch S6 and the control terminal of the fourth switch S4.

The first logic circuit unit 320 receives the first control signal in the first malfunction mode to terminate the supply of the reference voltage of the bias voltage.

The first control unit 310 includes a first AND gate AND1 and a first control switch SC1, and the first logic circuit unit 320 includes a second AND gate AND2. Input terminals of the first AND gate AND1 are connected to each other, and the output terminal of the first AND gate AND1 supplies a control signal to the control terminal T of the fifth switch S5 and the sixth switch S6 that control the bias voltage Vbias, and the output terminal of the first AND gate AND1 supplies a control signal to the control terminal of the first control switch SC1. The output terminal of the first AND gate AND1 is connected to the control terminal T of the fifth switch S5 and the sixth switch S6 that control the bias voltage Vbias, and the output terminal of the first AND gate AND1 is connected to the control terminal of the first control switch SC1. The control terminal of the first control switch SC1 is connected to the output terminal of the first AND gate AND1. One of the input terminals of the second AND gate AND2 is connected to the first control switch SC1. The other input terminal of the second AND gate AND2 is connected to the input terminal S4 in supplying a control signal to the control terminal of the reference voltage control switch S4.

When a high signal is supplied to the control terminal of the fourth switch S4 and the control terminal T in the first malfunction mode, the first AND gate AND1 outputs a high signal to the control terminal T of the fifth switch S5 and the sixth switch S6 that control the bias voltage Vbias of the sustain driver 115. Accordingly, the fifth switch S5 and the sixth switch S6 maintain a turn-on state. Meanwhile, since the first AND gate AND1 supplies a high signal to the control terminal of the first control switch SC1, the first control switch SC1 is turned on so that a low signal is supplied to one input terminal of the second AND gate AND2. Thus, the second AND gate AND2 outputs the low signal to the fourth switch S4 of the sustain driver 115 in response to the low signal inputted from the first control switch SC1 and the high signal inputted from the input terminal S4 in supplying a control signal to the control terminal of the reference voltage control switch S4, and the fourth switch S4 is turned off. Since the fourth switch S4 turns off, the supply of the reference voltage of the bias voltage is terminated so that the bias voltage Vbias may be stably supplied by the sustain driver 115.

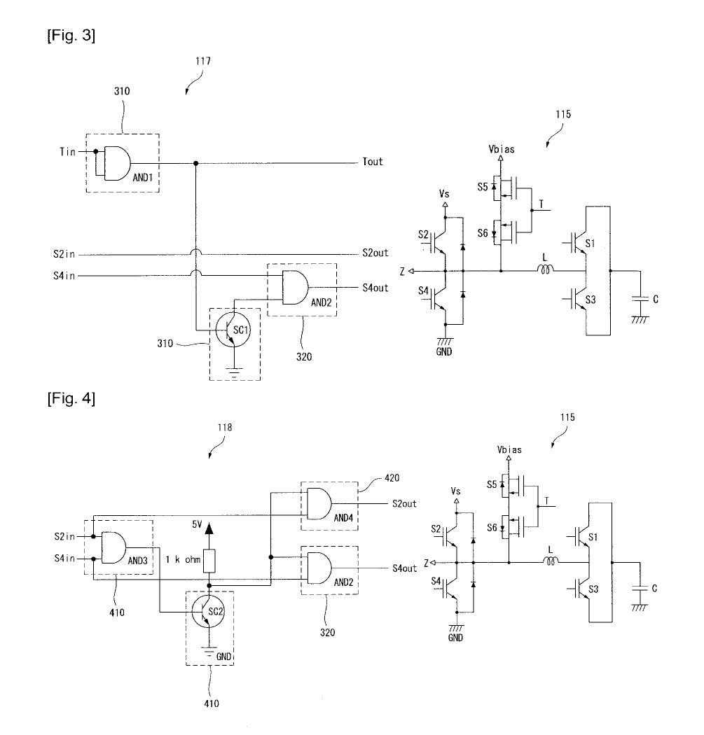

FIG. 4 is a view illustrating another example of the circuit protection unit shown in FIG. 1. Referring to FIG. 4, a second circuit protection unit 118 may include a second control unit 410 and a second logic circuit unit 420.

The second control unit 410 outputs a second control signal for terminating the supply of the reference voltage in a second malfunction mode where the sustain voltage Vs and the reference voltage of the sustain voltage are supplied simultaneously. The second control unit 410 includes a third AND gate AND3 and a second control switch SC2.

The second logic circuit unit 420 receives the second control signal to terminate the supply of the reference voltage of the sustain voltage. The second logic circuit unit 420 includes a second AND gate AND2 and a fourth AND gate AND4.

Input terminals S4 in and S2 in of the third AND gate AND3 are connected to the input terminal of the second AND gate AND2 and the input terminal of the fourth AND gate AND4, respectively, and the output terminals of the fourth AND gate AND4 and the second AND gate AND2 are connected to the second switch S2 and the fourth switch S4, respectively, and the output terminal of the third AND gate AND3 is connected to the control terminal of the second control switch SC2.

One input terminal of the fourth AND gate AND4 receives a control signal of the second switch S2 and the other input terminal of the fourth AND gate AND4 is connected to the second control switch SC2 and the output terminal of the fourth AND gate AND4 outputs a control signal to the control terminal of the second switch S2. One input terminal of the second AND gate AND2 receives a control signal of the fourth switch S4 and the other input terminal of the second AND gate AND2 is connected to the second control switch SC2 and the output terminal of the second AND gate AND2 outputs a control signal to the control terminal of the fourth switch S4.

When a high signal is supplied to the control terminal of the second switch S2 and the fourth switch S4 in the second malfunction mode, the sustain voltage Vs and the reference voltage of the sustain voltage are simultaneously supplied so that a short circuit is made within the sustain driver 115. At this time, since a high signal is supplied to the input terminals of the third AND gate AND3, the third AND gate AND3 supplies a high signal to the control terminal of the second control switch SC2.

Accordingly, the second control switch SC2 is turned on. When the second control switch SC2 turns on, a low signal is supplied to one input terminal of the fourth AND gate AND4 and the second AND gate AND2, and a high signal is supplied to the other input terminal of the fourth AND gate AND4 and the second AND gate AND2, so that the fourth AND gate AND4 and the second AND gate AND2 output the low signal to the control terminal of the second switch S2 and the control terminal of the fourth switch S4, respectively. Accordingly, the second switch S2 and the fourth switch S4 are turned off and this removes the short circuit, so that stable drive may be achieved.

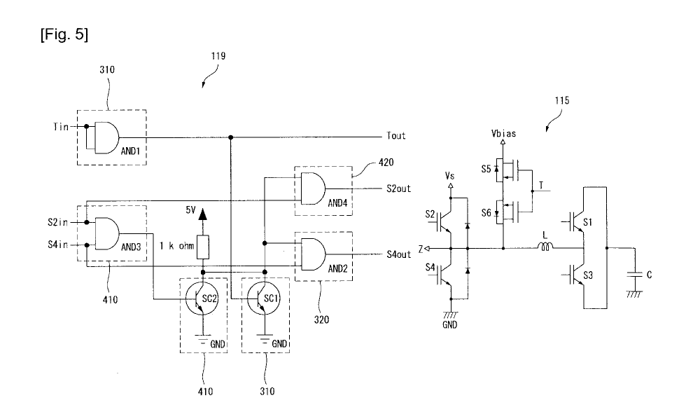

FIG. 5 is a view illustrating still another example of the circuit protection unit shown in FIG. 1. Referring to FIG. 5, a third circuit protection unit 119 is a combination of the first circuit protection unit 117 and the second circuit protection unit 118. When the first malfunction mode and the second malfunction mode occur at the same time or separately from each other, the third circuit protection unit 119 prevents a short circuit from being made within the sustain driver 115, thus making it possible to prohibit malfunction of the sustain driver 115.

The plasma display apparatus according to the exemplary embodiment may stably supply a driving signal so that the reliability in operation may be accomplished.

Embodiments of the invention being thus described, it will be obvious that the same may be varied in many ways. Such variations are not to be regarded as a departure from the scope of the invention, and all such modifications as would be obvious to one skilled in the art are intended to be included within the scope of the following claims.

### INDUSTRIAL APPLICABILITY

The plasma display apparatus according to the exemplary embodiment may stably supply a driving signal so that the reliability in operation may be accomplished.

The circuit protection unit of the plasma display apparatus prevents malfunction of the sustain driver to protect the sustain driver.

1. A plasma display apparatus comprising:
a plasma display panel having an electrode;
a driver adapted to supply the electrode with at least one of a bias voltage, a reference voltage of the bias voltage, a sustain voltage, and a reference voltage of the sustain voltage; and
a first circuit protection unit adapted to allow the bias voltage to be supplied and allow the supply of the reference voltage of the bias voltage to be terminated in a first malfunction mode where the bias voltage and the reference voltage of the bias voltage are simultaneously supplied.

2. A plasma display apparatus according to claim 1, wherein the first circuit protection unit includes a first control unit adapted to output a first control signal for terminating the supply of the reference voltage of the bias voltage in the first malfunction mode where the bias voltage and the reference voltage of the bias voltage are simultaneously supplied, and
a first logic circuit adapted to receive the first control signal to terminate the supply of the reference voltage of the bias voltage.

3. A plasma display apparatus according to claim 2, further comprising:
a second circuit protection unit adapted to allow the supply of the sustain voltage and the reference voltage of the sustain voltage to be terminated in a second malfunction mode where the sustain voltage and the reference voltage of the sustain voltage are simultaneously supplied.

4. A plasma display apparatus according to claim 3, wherein the second circuit protection unit includes a second control unit adapted to output a second control signal for terminating the supply of the sustain voltage and the reference voltage of the sustain voltage in the second malfunction mode where the sustain voltage and the reference voltage of the sustain voltage are simultaneously supplied, and a second logic circuit unit adapted to receive the second control signal to terminate the supply of the reference voltage of the sustain voltage.

5. A plasma display apparatus according to claim 2, wherein the first control unit includes a first AND gate and a first control switch, and the first logic circuit unit includes a second AND gate,
in the first malfunction mode, the first AND gate outputs a high signal to a bias voltage control terminal of the driver and a control terminal of the first control switch,
the first control switch supplies a low signal to an input terminal of the second AND gate,
the second AND gate supplies a low signal to a reference voltage control terminal of the driver to terminate the supply of the reference voltage.

6. A plasma display apparatus according to claim 5, wherein input terminals of the first AND gate are connected to each other, an output terminal of the first AND gate is connected to a control terminal of a switch controlling a bias voltage, the output terminal of the first AND gate is connected to the control terminal of the first control switch, and one of input terminals of the second AND gate is connected to the first control switch,
the other of input terminals of the second AND gate is connected to an input terminal supplying a control signal to a control terminal of the reference voltage control switch of the bias voltage.

7. A plasma display apparatus according to claim 4, wherein the second control unit includes a third AND gate and a second control switch, and the second logic circuit unit includes a second AND gate and a fourth AND gate,
in the second malfunction mode, the third AND gate outputs a high signal to a control terminal of the second control switch,
an input terminal of the second AND gate receives a low signal when the second control switch turns on to terminate the supply of the reference voltage of the sustain voltage,
an input terminal of the fourth AND gate receives a low signal when the second control switch turns on to terminate the supply of the sustain voltage.

8. A plasma display apparatus according to claim 7, wherein input terminals of the third AND gate are connected to an input terminal of the second AND gate and an input terminal of the fourth AND gate, respectively,
an output terminal of the fourth AND gate is connected to a sustain voltage control terminal,
an output terminal of the second AND gate is connected to a reference voltage control terminal of the sustain voltage,
an output terminal of the third AND gate is connected to a control terminal of the second control switch,
the other of the input terminals of the fourth AND gate is connected to the second control switch,
the other of the input terminals of the second AND gate is connected to the second control switch.

9. A plasma display apparatus according to claim 1, wherein the reference voltage of the sustain voltage is equal to the reference voltage of the bias voltage.

10. A plasma display apparatus comprising:
a plasma display panel having an electrode;
a driver adapted to supply the electrode with at least one of a bias voltage, a reference voltage of the bias voltage, a sustain voltage, and a reference voltage of the sustain voltage; and
a second circuit protection unit adapted to allow the supply of the sustain voltage and the reference of the sustain voltage to be terminated in a second malfunction mode where the sustain voltage and the reference voltage of the sustain voltage are simultaneously supplied.

11. A plasma display apparatus according to claim 10, wherein the second circuit protection unit includes
a second control unit adapted to output a second control signal for terminating the supply of the sustain voltage and the reference voltage of the sustain voltage in the second malfunction mode where the sustain voltage and the reference voltage of the sustain voltage are simultaneously supplied, and
a second logic circuit unit adapted to receive the second control signal to terminate the supply of the reference voltage of the sustain voltage.

12. A plasma display apparatus according to claim 11, wherein the second control unit includes a third AND gate and a second control switch, and the second logic circuit unit includes a second AND gate and a fourth AND gate,
in the second malfunction mode, the third AND gate outputs a high signal to a control terminal of the second control switch,
an input terminal of the second AND gate receives a low signal when the second control switch turns on to terminate the supply of the reference voltage of the sustain voltage,
an input terminal of the fourth AND gate receives a low signal when the second control switch turns on to terminate the supply of the sustain voltage.

13. A plasma display apparatus according to claim 12, wherein input terminals of the third AND gate are connected to an input terminal of the second AND gate and an input terminal of the fourth AND gate, respectively,
an output terminal of the fourth AND gate is connected to a sustain voltage control terminal,
an output terminal of the second AND gate is connected to a reference voltage control terminal of the sustain voltage,
an output terminal of the third AND gate is connected to a control terminal of the second control switch,
the other of the input terminals of the fourth AND gate is connected to the second control switch,
the other of the input terminals of the second AND gate is connected to the second control switch.
